(19) United States
(12) Patent Application Publication
(10) Pub. No.: US 2009/0252006 A1
(43) Pub. Date: Oct. 8, 2009

(54) OPTICAL DISC DEVICE AND CONTROL METHOD

(75) Inventors: Kazumi SUGIYAMA, Kawasaki-shi (JP); Hiroshi NAKANE, Fukaya-shi (JP); Hirokazu SHOU, Musashimurayama-shi (JP); Tadashi KIKUTA, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/415,891

(22) Filed: Mar. 31, 2009

(30) Foreign Application Priority Data
Mar. 31, 2008 (JP) 2008-094159

(51) Int. Cl. G11B 7/00

(52) U.S. Cl. 369/47.5; G9B/7

(57) ABSTRACT

According to one embodiment, an optical disc device includes a semiconductor laser which generates laser light to irradiate an optical disc, and an automatic power control circuit which detects an optical output of the semiconductor laser, sets driving current data equalized to reflect the detection result, and drives the semiconductor laser based on the driving current data. This optical disc device further includes a protection circuit which monitors the driving current data set in the automatic power control circuit to invalidate the driving current data in a case where the abnormality of the driving current data is detected.

### CROSS-REFERENCE TO RELATED APPLICATIONS

This application is based upon and claims the benefit of priority from Japanese Patent Application No. 2008-094159, filed Mar. 31, 2008, the entire contents of which are incorporated herein by reference.

### BACKGROUND

1. Field

One embodiment of the present invention relates to an optical disc device in which laser power is digitally controlled by a software system, and a control method.

2. Description of the Related Art

In recent years, the integration degree of a digital IC has rapidly progressed. Accordingly, a part of control hardware of an optical disc device is integrated as the digital IC, and a semiconductor laser such as a laser diode is controlled by a software system, whereby the decrease of costs is achieved.

In a general optical disc device, an automatic power control circuit (APC) is provided to fixedly maintain an optical output (laser power) of the semiconductor laser, and a part of the circuit includes a microcomputer which operates in accordance with a software program. The optical output of the semiconductor laser is detected by a photosensor, and the automatic power control circuit (APC) drives the semiconductor laser based on the output of this photosensor.

On the other hand, the above semiconductor laser is destroyed by, for example, an excessively large laser driving current which temporarily flows owing to an influence of noise or the like. For protecting the semiconductor laser from such destruction, there has heretofore been suggested a technology in which the detection result of the optical output is used (e.g., see Jpn. Pat. Appln. KOKAI Publication No. 07-65402).

However, in recent years, a photosensor IC having a gain adjustment function has been present. When the photosensor IC becomes a gain setting of a low sensitivity owing to the runaway of the microcomputer, the above technology cannot securely protect the semiconductor laser.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the configuration of an optical disc device according to one embodiment of the present invention;

FIG. 2 is an exemplary diagram showing the configuration of an automatic power control circuit shown in FIG. 1;

FIG. 3 is an exemplary diagram showing the change of driving current data monitored by a laser protection circuit shown in FIG. 2;

FIG. 4 is an exemplary diagram showing the configuration of the laser protection circuit shown in FIG. 2;

FIG. 5 is an exemplary diagram showing an operation of the laser protection circuit shown in FIG. 4;

FIG. 6 is an exemplary diagram showing a modification of the laser protection circuit shown in FIG. 4;

FIG. 7 is an exemplary diagram showing an operation of the modification of the laser protection circuit shown in FIG. 6;

FIG. 8 is an exemplary diagram showing another modification of the laser protection circuit shown in FIG. 4; and

FIG. 9 is an exemplary diagram showing an operation of the other modification of the laser protection circuit shown in FIG. 8.

### DETAILED DESCRIPTION

Various embodiments according to the invention will be described hereinafter with reference to the accompanying drawings.

According to one embodiment of the present invention, there is provided an optical disc device comprising: a semiconductor laser configured to generate laser light to irradiate an optical disc; an output control circuit configured to detect an optical output of the semiconductor laser, set driving current data equalized to reflect a result of detection and drive the semiconductor laser based on the driving current data; and a protection circuit configured to monitor the driving current data set in the output control circuit to invalidate the driving current data in a case where an abnormality of the driving current data is detected.

According to one embodiment of the present invention, there is provided a control method of an optical disc device including a semiconductor laser configured to generate laser light to irradiate an optical disc, and an output control circuit configured to detect an optical output of the semiconductor laser, set driving current data equalized to reflect a result of detection, and drive the semiconductor laser based on the driving current data, the method comprising: monitoring the driving current data set in the output control circuit; and invalidating the driving current data in a case where an abnormality of the driving current data is detected.

In the optical disc device and the control method, the driving current data set in the output control circuit is monitored, and in a case where an abnormality is detected, the driving current data is invalidated. Therefore, even if a part of the output control circuit is a firmware block such as a microcomputer, the abnormality of the driving current data due to the runaway of the microcomputer can be recognized. Moreover, even when gain adjustment is performed to detect the optical output of the semiconductor laser, the detection result of the optical output is not utilized in detecting the abnormality, and hence the semiconductor laser can remarkably securely be protected from the runaway of the firmware block.

Hereinafter, an optical disc device according to one embodiment of the present invention will be described.

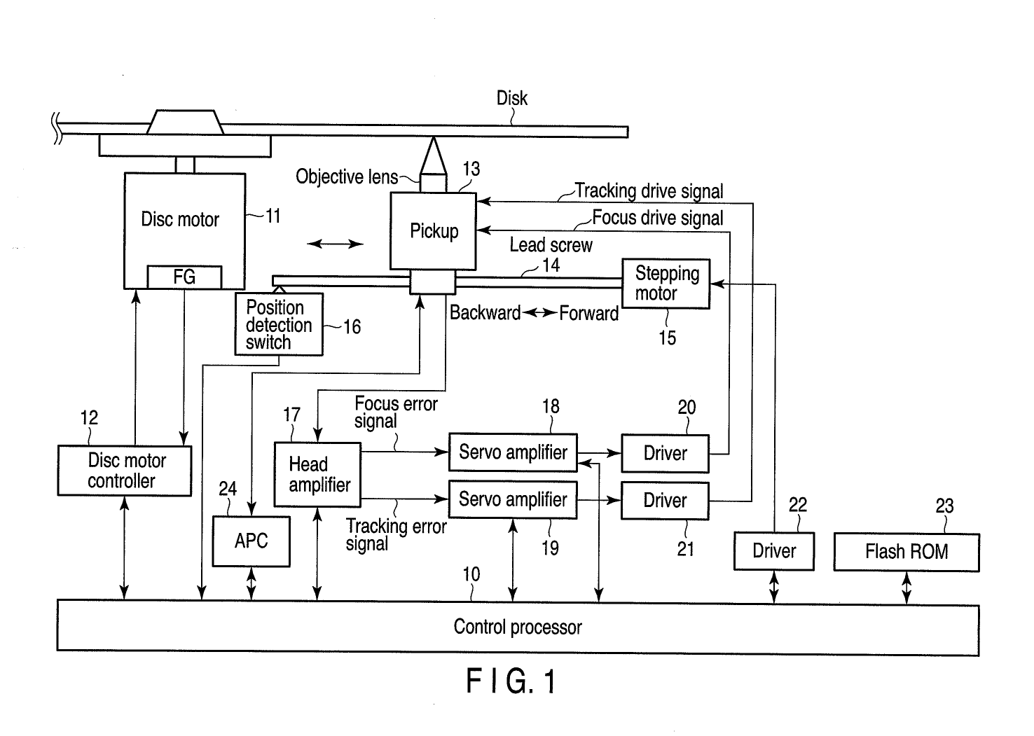

FIG. 1 shows the configuration of the optical disc device. An optical disc is rotatably attached to a disc motor 11. The disc motor 11 is provided with a frequency generator FG. A control processor 10 compares a rotation angle signal from the frequency generator FG with an internal reference frequency to control a disc motor control section 12 so that the disc motor 11 is set to a predetermined rotating direction and a rotation number in accordance with an error signal of the comparison result.

A pickup 13 is provided to face an information recording face of a disc, supported by a sliding axis (not shown) to be movable in the radial direction of the disc, and moved by a lead screw 14. A step motor 15 is a feed motor of the pickup 13, and a rotary shaft thereof is directly connected to the lead screw 14. A position detecting switch 16 is arranged in a home position of the pickup 13, and hence when the pickup 13 moves to the inner peripheral side of the disc to come in contact with the position detecting switch 16, it is detected that the pickup 13 has reached the home position. This position detecting switch 16 is utilized for the initialization of the position of the pickup 13.

The laser light is divided into three beams by a diffraction grating. The beams are condensed by an objective lens through optical components (not shown) in the pickup 13, and the thus condensed light irradiates the information recording face of the disc so as to form a spot thereon. The laser light reflected by the disc returns to the objective lens to enter an eight-divided detector through the internal optical components. A focus error signal is based on an astigmatism method, and a tracking error signal is based on a DPP method. The detector performs current-voltage conversion of the incident light by an IC in the pickup, and outputs a signal of the conversion result to a predetermined head amplifier 17.

The objective lens is supported by a spring, and supported movably in a light axis direction (a focusing direction) of the laser light and a radial direction (a tracking direction) of the disc. Here, coils and magnets are provided to drive the objective lens in the focusing direction and the tracking direction. Such a two-directional movement member is referred to as a biaxial actuator. A focusing coil is driven by a focus drive signal output from a driver 20, and a tracking coil is driven by a tracking drive signal output from a driver 21. The drivers 20 and 21 are connected to servo amplifiers 18 and 19, respectively. The servo amplifier 18 is controlled by the control processor 10 to generate the focus drive signal in accordance with the focus error signal from the head amplifier 17. The servo amplifier 19 is controlled by the control processor 10 to generate the tracking drive signal in accordance with the tracking error signal from the head amplifier 17.

The control processor 10 acquires disc address information from a high-frequency (RF) signal obtained as an information signal and other signals from the head amplifier 17 by use of CD, DVD and high-density recording DVD demodulators and address decoders (not shown). In the process of controlling a step motor 15, the control processor 10 generates 2-phase sinusoidal signals, power-amplifies the signals, and outputs the thus amplified signals to the driver 22.

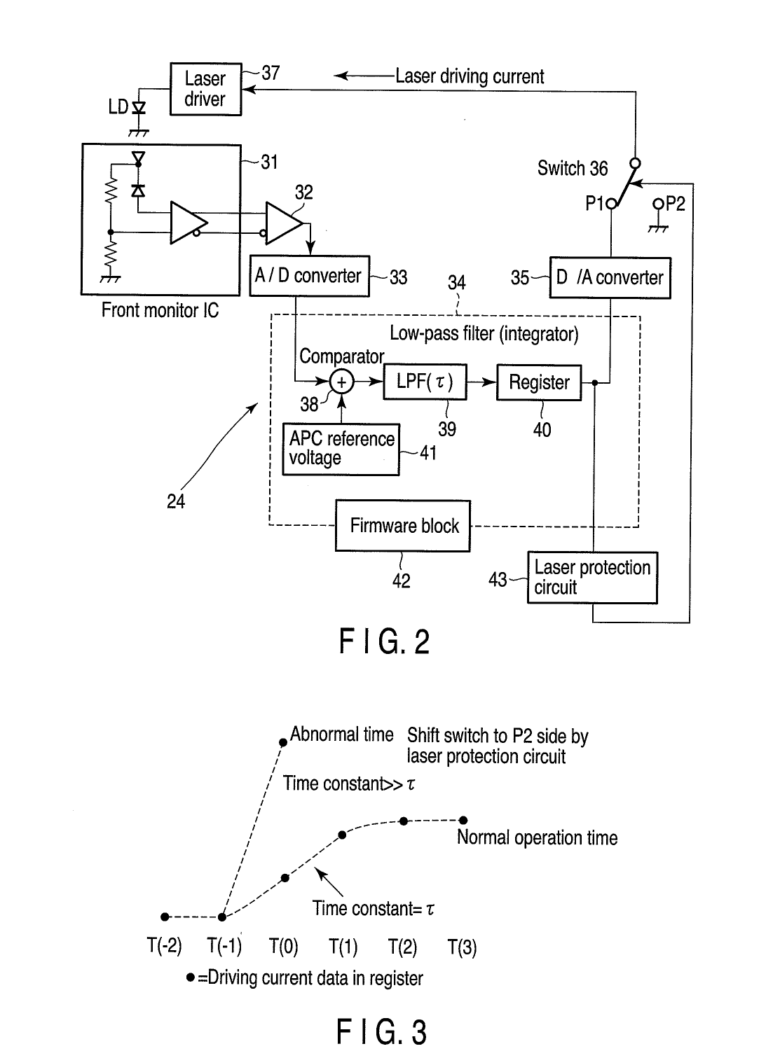

FIG. 2 shows the configuration of an automatic power control circuit 24 shown in FIG. 1. The pickup 13 is provided with a semiconductor laser LD as a laser light source to generate the laser light with which the optical disc is irradiated. The automatic power control circuit 24 includes a front monitor IC 31 which has a gain adjustment function and which detects the optical output of the semiconductor laser LD; an amplifier 32 which amplifies an output signal of the front monitor IC 31; an analog-to-digital converter 33 which converts an output signal of the amplifier 32 into a digital form; a microcomputer 34 as a firmware block which sets driving current data equalized to reflect the optical detection result obtained from the analog-to-digital converter 33; a digital-to-analog converter 35 which changes the driving current data into an analog form; a switch 36 which selectively outputs a laser driving current obtained from the digital-to-analog converter 35; and a laser driving section 37 which drives the semiconductor laser LD in accordance with the laser driving current.

The microcomputer 34 includes a comparator 38 which compares data of the optical detection result obtained from the analog-to-digital converter 33 with APC reference voltage data; a low-pass filter (an integrator) 39 having an equalizer function of phase-compensating for the comparison result; and a register 40 which stores the driving current data output from the low-pass filter 39 under the reflection of the detection result of the optical output. In the phase compensation, frequency characteristics of an error signal obtained as the comparison result from the comparator 38 are compensated and amplified. The driving current data is set as the result of the processing in the register 40.

The microcomputer 34 is connected to a laser protection circuit 43. When the laser protection circuit 43 monitors the driving current data stored in the register 40 and detects the abnormality of the driving current data, the switch 36 is switched from a P1 side to a P2 side to invalidate the driving current data. Here, as shown in FIG. 3, when the change ratio of the driving current data exceeds a predetermined value depending on a time constant=τ of the low-pass filter 39, this is detected as an abnormality. When the microcomputer 34 normally operates, the driving current data in the register 40 changes in accordance with the time constant=τ of the low-pass filter 39. In a case where the contents of the register 40 change faster than the time constant=τ, it is supposed that the microcomputer 34 runs away.

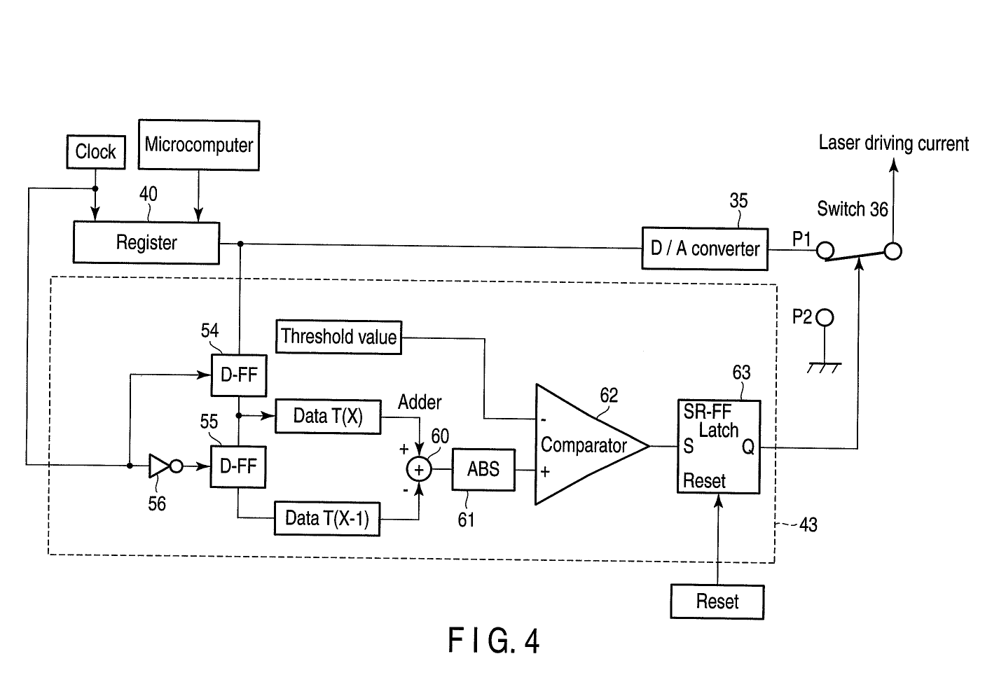

FIG. 4 shows the configuration of the laser protection circuit 43. The laser protection circuit 43 includes a D-type flip-flop 54 which takes the driving current data stored in the register 40; a D-type flip-flop 55 which takes the driving current data from the D-type flip-flop 54; an inverter 56 which inverts a clock to the register 40 and the D-type flip-flop 54 to supply the same to the D-type flip-flop 55; an adder 60 which adds up output data Data T(X) of the D-type flip-flop 54 and output data Data T(X−1) of the D-type flip-flop 55; an absolute value circuit (ABS) 61 which obtains an absolute value of an output of the adder 60; a comparator 62 which compares the output value of the absolute value circuit 61 with a predetermined threshold value corresponding to the time constant τ; and a latch 63 which is an SR-flip-flop to take the output result of the comparator 62. The latch 63 can be reset in accordance with a reset signal from the outside.

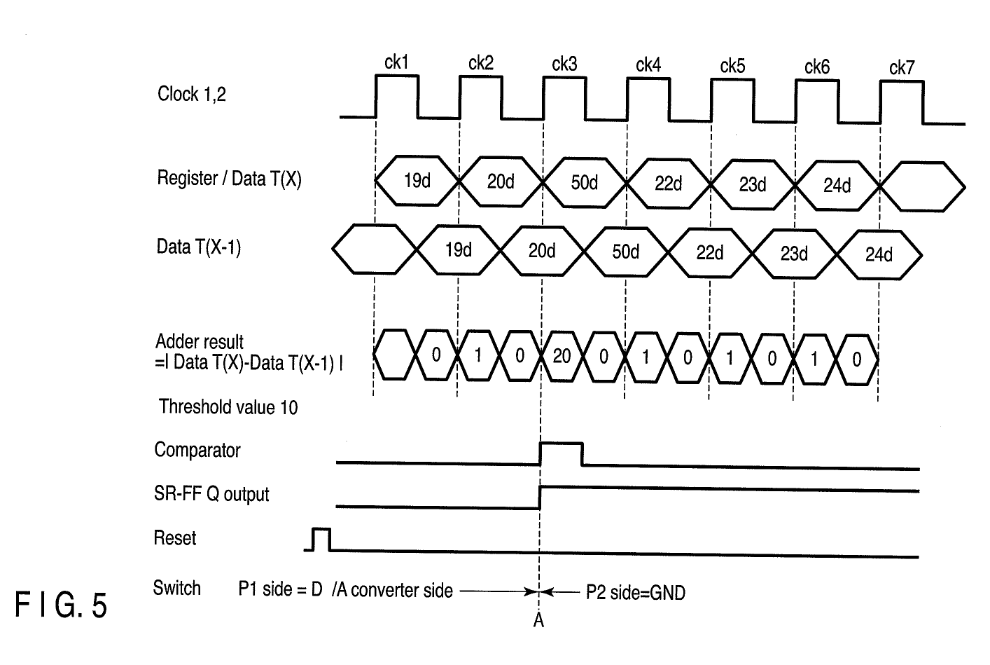

FIG. 5 shows an operation of the laser protection circuit. The D-type flip-flops 54, 55 take data while delaying the data in accordance with the clock to update the data in the register 40 by the microcomputer 34, and the adder 60 and the absolute value circuit 61 obtain, as the change ratio of the data, an absolute value of a difference between the present output data Data T(X) and the past output data Data T(X−1). In a case where the comparator 62 compares the change ratio with the threshold value to detect that the change ratio exceeds the threshold value, an output signal to the latch 63 is raised to a high level. In consequence, the latch 63 shifts the switch 36 from the P1 side to the P2 side.

In the present embodiment, the laser protection circuit 43 monitors the driving current data set in the automatic power control circuit 24, and invalidates the driving current data in a case where the abnormality is detected. In consequence, even when a part of the automatic power control circuit 24 is the microcomputer 34 operating in accordance with the software program, the abnormality of the driving current data due to the runaway of the microcomputer can be recognized. Moreover, even in a case where the front monitor IC 31 performs the gain adjustment to detect the optical output of the semiconductor laser LD, the detection result of the optical output is not utilized for the detection of the abnormality, and hence the semiconductor laser can remarkably securely be protected from the runaway of the microcomputer 34.

It is to be noted that the present invention is not limited to the above embodiment, and can variously be modified without departing from the scope of the present invention.

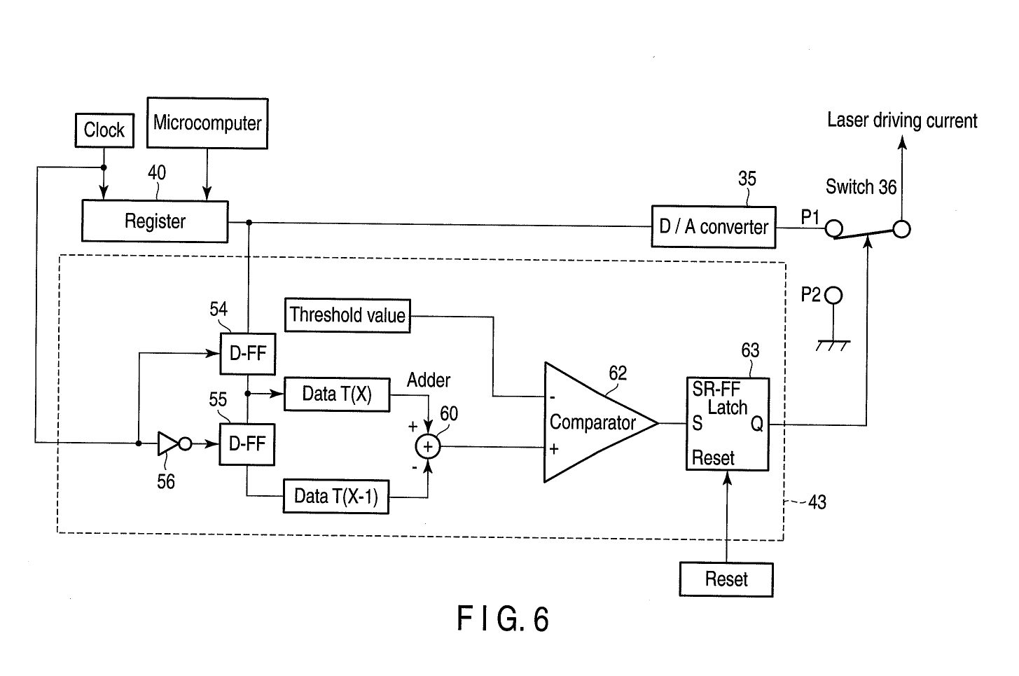

FIG. 6 shows a modification of the laser protection circuit 43 shown in FIG. 4. Here, the absolute value circuit 61 shown in FIG. 4 is omitted. That is, the output of an adder 60 is directly supplied to a comparator 62.

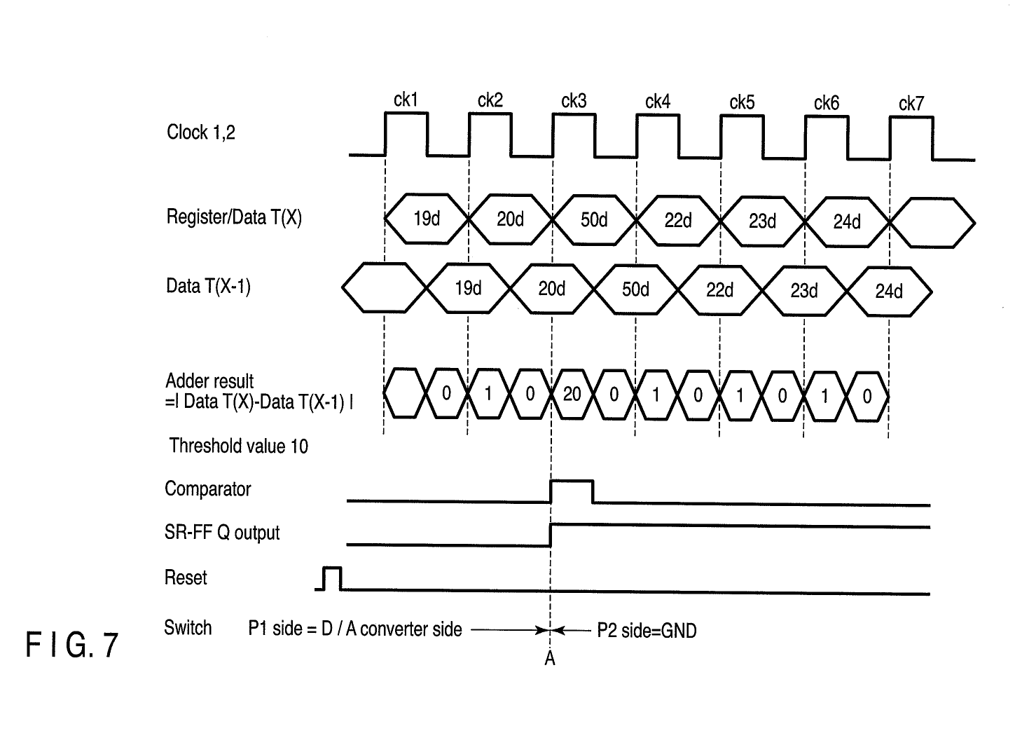

FIG. 7 shows an operation of the modification. D-type flip-flops 54, 55 take data while delaying the data in accordance with a clock to update the data in a register 40 by a microcomputer 34, and the adder 60 obtains, as the change ratio of the data, a difference between the present output data Data T(X) and the past output data Data T(X−1). In a case where the comparator 62 compares the change ratio with the threshold value to detect that the change ratio exceeds the threshold value, an output signal to a latch 63 is raised to a high level. In consequence, the latch 63 shifts the switch 36 from a P1 side to a P2 side.

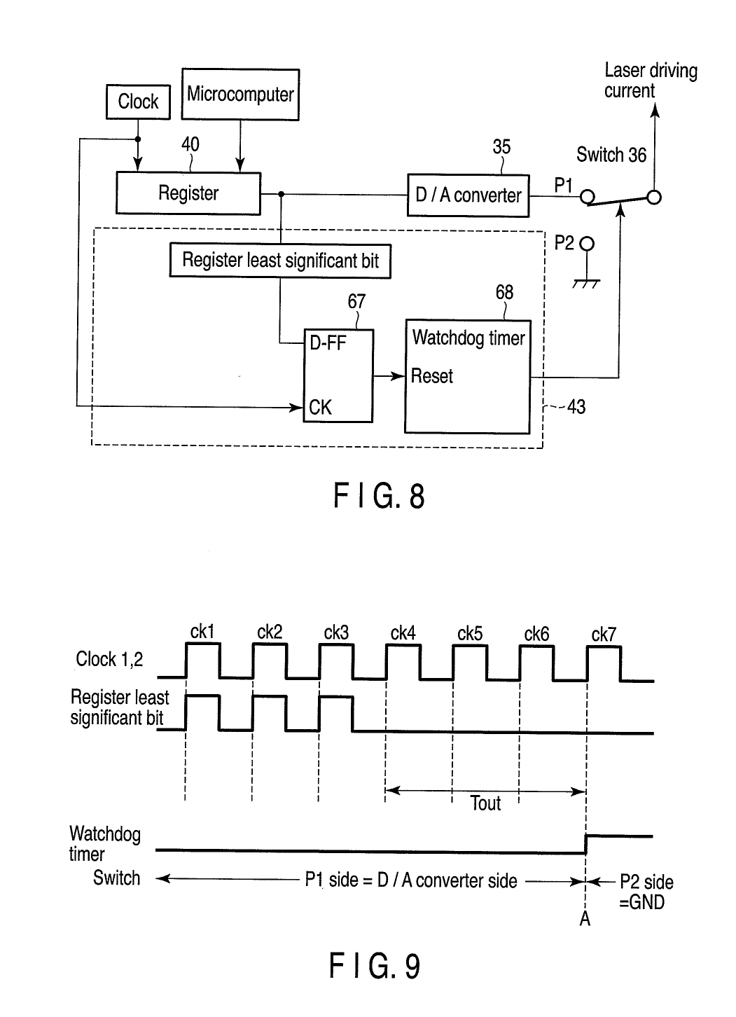

FIG. 8 shows another modification of the laser protection circuit 43. In this modification, the laser protection circuit 43 includes a D-type flip-flop 67 which takes the least significant bit of a register 40 and a watchdog timer 68 which is reset by driving current data output from the D-type flip-flop 67. The D-type flip-flop 67 takes the least significant bit with a clock to update data in the register 40 by a microcomputer 34.

FIG. 9 shows an operation of another modification. In the watchdog timer 68, it is detected as an abnormality that any change of the driving current data output from the D-type flip-flop 67 is not present for a predetermined period. In this case, the switch 36 is shifted from a P1 side to a P2 side. It is to be noted that the modification may be combined with the constitution shown in FIG. 4 or 6.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc device comprising:
a semiconductor laser configured to emit laser light to irradiate an optical disc;
an output controller configured to detect an optical output of the semiconductor laser, to set driving current data equalized in response to a result of a detection of the optical output and to drive the semiconductor laser based on the driving current data; and
a protection circuit configured to monitor the driving current data set in the output controller in order to invalidate the driving current data when an anomaly in the driving current data is detected.

2. The optical disc device of claim 1, wherein the protection circuit is configured to detect the anomaly when the change ratio of the driving current data exceeds a predetermined value.

3. The optical disc device of claim 1, wherein the protection circuit is configured to detect the anomaly if no change of the driving current data has been detected for a predetermined period.

4. The optical disc device of claim 1, wherein the output controller is configured to obtain the driving current data by firmware processing and to store the driving current data in a register.

5. The optical disc device of claim 4, wherein the protection module is configured to receive the driving current data from the register in order to monitor the driving current data.

6. A control method of an optical disc device comprising a semiconductor laser configured to emit laser light to irradiate an optical disc, and an output controller configured to detect an optical output of the semiconductor laser, to set driving current data equalized in response to a result of detection, and to drive the semiconductor laser based on the driving current data, the method comprising:
monitoring the driving current data set in the output controller; and
invalidating the driving current data when an anomaly in the driving current data is detected.

7. The control method of claim 6, further comprising detecting the anomaly when the change ratio of the driving current data exceeds a predetermined value.

8. The control method of claim 6, further comprising detecting the anomaly if no change of the driving current data has been detected for a predetermined period.

9. The control method of claim 6, further comprising obtaining the driving current data by firmware processing and storing the driving current data in a register.

10. The control method of claim 9, further comprising receiving the driving current data from the register in order to monitor the driving current data.
